(19) United States
(12) Patent Application Publication
(10) Pub. No.: US 2026/0141887 A1
(43) Pub. Date: May 21, 2026

(54) ACTIVE NOISE CANCELLATION

(71) Applicant: Analog Devices, Inc., Wilmington, MA (US)

(72) Inventor: Alan Christopher O'CONNOR, Dedham, MA (US)

(21) Appl. No.: 18/950,371

(22) Filed: Nov. 18, 2024

(51) Int. Cl. G10K 11/178

(52) U.S. Cl. CPC G10K 11/17881

(57) ABSTRACT

The technology may include: reference sensor(s); speaker(s); at least one error microphone array unit, each error microphone array unit comprising at least two error microphones; memory storing instructions therein; and processors: communicatively coupled with the memory, each reference sensor, each speaker, and each error microphone array unit. The processors are configured to execute the instructions to: receive reference sensor signal(s) related to a noise source from each reference sensor situated in relation to the noise source, generate anti-noise waveform(s) for the noise source based on the received reference sensor signals, transmit the generated anti-noise from the speaker situated in relation to a quiet zone, receive error signal(s) related to residual noise, from each error microphone array unit situated in relation to the quiet zone; and adapt the anti-noise waveform based on the error signal to cancel noise from the noise source in the quiet zone.

### FIELD OF THE DISCLOSURE

This disclosure relates to active noise cancellation, generally. More specifically, the disclosure describes technology for the use of error microphone array units in active noise cancellation.

### BACKGROUND

Active noise cancellation (ANC) refers to a set of techniques and technologies for reducing noise in a given zone (a “quiet zone”) by transmitting “anti-noise” (a sound wave with similar amplitude but inverted phase as the noise) into the quiet zone. The anti-noise combines with the noise via destructive interference to reduce the volume of noise experienced in the quiet zone.

In vehicles, noise in the vehicle cabin can originate as wind noise, engine noise, and road noise. Wind noise is typically broadband, random and comes from diffuse locations, and therefore difficult to cancel. Engine noise is typically narrowband and tonal; and can be cancelled using engine order cancellation technologies. Road noise from suspension and tire-to-road contact is relatively low frequency (e.g., 30 Hz-500 Hz) and originates from a small number of points, but is random, and so is best addressed using feedforward noise cancellation technology.

### SUMMARY OF THE DISCLOSURE

In some aspects, the techniques described herein relate to an active noise cancellation (ANC) system, including: at least one reference sensor; at least one speaker; at least one error microphone array unit, each error microphone array unit including at least two error microphones; a memory storing instructions therein; and one or more processors: communicatively coupled with i) the memory, ii) each reference sensor, iii) each speaker, and iv) each error microphone array unit; and configured to execute the instructions to: receive reference sensor signals related to a noise source from each reference sensor situated in relation to the noise source; generate an anti-noise for the noise source based on the received reference sensor signals; transmit the generated anti-noise from the speaker situated in relation to a quiet zone; receive at least one error signal, related to residual noise, from each error microphone array unit situated in relation to the quiet zone; and adapt the anti-noise based on the error signal to cancel noise from the noise source in the quiet zone.

In some aspects, the techniques described herein relate to an active noise cancellation (ANC) method, including: receiving, in one or more processors, reference sensor signals related to a noise source from each of at least one reference sensor situated in relation to a noise source; generating, by the one or more processors, an anti-noise waveform for the noise source based on the received reference sensor signals; transmitting, by the one or more processors to one or more speakers to be broadcast from one or more speakers situated in relation to a quiet zone, the generated anti-noise waveform; receiving, by the one or more processors, at least one error signal, related to residual noise, from each of one or more error microphone array unit situated in relation to the quiet zone, each error microphone array unit including a plurality of error microphones; and adapting, by the one or more processors, the anti-noise waveform based on the error signal to cancel noise from the noise source in the quiet zone.

In some aspects, the techniques described herein relate to a non-transitory computer-readable medium storing computer executable instructions, the instructions when executed by one or more processors in a network is operative to: receive reference sensor signals related to a noise source from each of at least one reference sensor situated in relation to a noise source; generate, by the one or more processors, anti-noise for the noise source based on the received reference sensor signals; transmit, by the one or more processors to one or more speakers to be broadcast from one or more speakers situated in relation to a quiet zone, the generated anti-noise; receive, by the one or more processors, at least one error signal, related to residual noise, from each of one or more error microphone array unit situated in relation to the quiet zone, each error microphone array unit including a plurality of error microphones; and adapt, by the one or more processors, the anti-noise based on the error signal to cancel noise from the noise source in the quiet zone.

In some aspects, the techniques described herein relate to a vehicle, including: at least one reference sensor; at least one speaker; at least one error microphone array unit, each error microphone array unit including at least two error microphones; a memory storing instructions therein; and one or more processors: communicatively coupled with i) the memory, ii) each reference sensor, iii) each speaker, and iv) each error microphone array unit; and configured to execute the instructions to: receive reference sensor signals related to a noise source from each reference sensor situated in relation to the noise source; generate anti-noise for the noise source based on the received reference sensor signals; transmit the generated anti-noise from the speaker situated in relation to a quiet zone; receive at least one error signal, related to residual noise, from each error microphone array unit situated in relation to the quiet zone; and adapt the anti-noise based on the error signal to cancel noise from the noise source in the quiet zone.

### BRIEF DESCRIPTION OF THE DRAWINGS

The present technology will now be described in more detail with reference to the accompanying drawings, which are not intended to be limiting.

FIG. 1 illustrates example portions of an ANC system, also referred to as road noise cancellation (RNC) system in a vehicle, in accordance with examples of the technology disclosed herein.

FIG. 2 illustrates a filtered reference least mean squared (FxLMS) approach to ANC/RNC without virtual sensing, in accordance with examples of the technology disclosed herein.

FIG. 3 illustrates an example error microphone array unit and an example polar pattern derived from performing digital signal processing on the raw signals from the microphones, in accordance with examples of the technology disclosed herein.

FIG. 4 illustrates methods for active noise cancellation, in accordance with examples of the technology disclosed herein.

FIG. 5 illustrates methods for active noise cancellation, in accordance with examples of the technology disclosed herein.

FIG. 6 illustrates methods for active noise cancellation using remote microphone technology (RMT) is illustrated, in accordance with examples of the technology disclosed herein.

FIG. 7 illustrates methods for active noise cancellation, in accordance with examples of the technology disclosed herein.

FIG. 8 illustrates methods for active noise cancellation using auxiliary filtering-virtual sensing (AF-VS), in accordance with examples of the technology disclosed herein.

FIG. 9 illustrates a beamformer architecture, in accordance with examples of the technology disclosed herein.

FIG. 10 illustrates an arrangement for beamforming at an error microphone array module to mitigate interference from speech by vehicle occupants, in accordance with examples of the technology disclosed herein.

FIG. 11 schematically illustrates a device that may serve as a computer, processor, host, etc., in accordance with examples of the technology disclosed herein.

### DETAILED DESCRIPTION

In the following detailed description, reference is made to the accompanying drawings which form a part hereof wherein like numerals designate like parts throughout, and in which is shown by way of illustration examples that may be practiced. It is to be understood that other examples may be utilized, and structural or logical changes may be made, without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. These operations may not be performed in the order of presentation. Operations described may be performed in a different order than the described example. Various additional operations may be performed and/or described operations may be omitted in additional examples.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

Various components may be referred to or illustrated herein in the singular (e.g., a “processor,” a “peripheral device,” etc.), but this is simply for ease of discussion, and any element referred to in the singular may include multiple such elements in accordance with the teachings herein.

The description uses the phrases “in an example” or “in examples,” which may each refer to one or more of the same or different examples. Furthermore, the terms “comprising,” “including,” “having,” and the like, as used with respect to examples of the present disclosure, are synonymous. As used herein, the term “circuitry” may refer to, be part of, or include an application-specific integrated circuit (ASIC), an electronic circuit, and optical circuit, a processor (shared, dedicated, or group), and/or memory (shared, dedicated, or group) that execute one or more software or firmware programs, a combinational logic circuit, and/or other suitable hardware that provide the described functionality.

While examples herein are in the context of ANC systems in the cabins of motor vehicle, e.g., road noise cancellation (RNC), the technology disclosed herein is applicable to other environments, e.g., appliances, machinery, offices. Road noise in a vehicle may be annoying, may cause driver fatigue, and may impede both entertainment systems and voice user interfaces found in modern vehicles. In electric vehicles, road noise can be the predominant source of noise. The use of active ANC/RNC systems in vehicles is also favored to reduce cabin noise because passive mitigation measures (especially for low frequency noise) can be heavy.

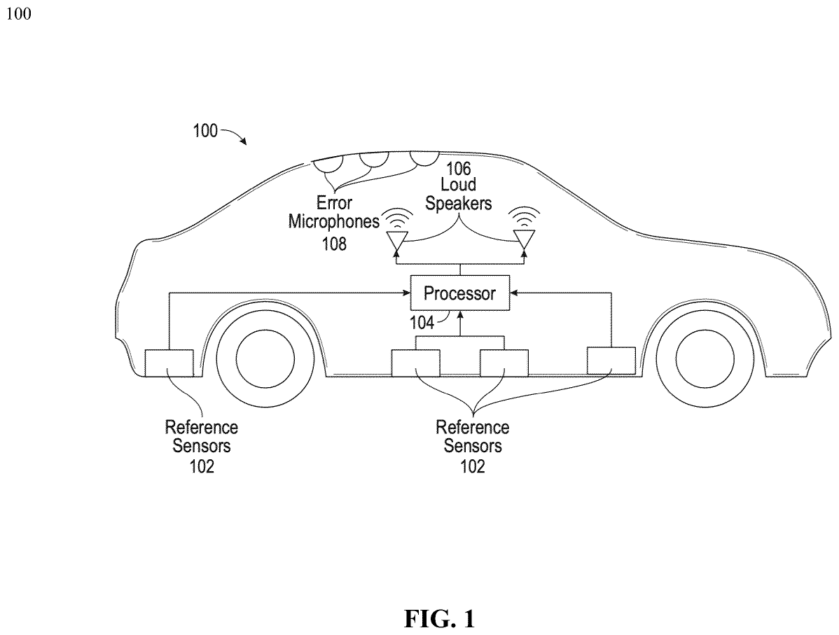

FIG. 1 illustrates example portions of an ANC system 100, also referred to as road noise cancellation (RNC) system in a vehicle, in accordance with examples of the technology disclosed herein. The ANC system 100 includes reference sensor(s) 102, processor(s) 104 (e.g., digital signal processor (DSP)), speaker(s) 106, and an error microphone(s) 108.

Reference sensor(s) 102, e.g., accelerometers and microphones, are placed near the wheels of the vehicle (noise sources). The reference sensor(s) 102 can sense vibrations that may be correlated with the road noise that passes into the vehicle cabin (the location of one or more quiet zones). In some examples, four reference sensor(s) 102 may be provided, one reference sensor 102 (e.g., accelerometers) for each wheel of the vehicle. In some examples, each reference sensor 102 may include three axes, generating twelve channels of reference signal(s).

Processor(s) 104 may be provided as one or more microprocessors, such as digital signal processors (DSPs), and memory storing instructions that when executed by the processor(s) 104 operate to reduce noise in a quiet zone. The processor(s) 104 may receive the reference signal(s) from the reference sensor(s) 102 and may generate an anti-noise signal based on the reference signal(s), e.g., using a finite impulse response (FIR) filter. The anti-noise signal may be 180° out of phase with the disturbance noise waves so that the anti-noise signal destructively interferes with the disturbance noise waves to cancel the noise in the vehicle cabin. The anti-noise signal may be transmitted to the speaker(s) 106, which may output the anti-noise signal. The error microphone(s) 108 may detect the noise level in the vehicle and may transmit information to the processor(s) 104 in a feedback loop to modify the noise cancellation accordingly. The FIR filter(s) typically synthesize anti-noise with a latency measured in milliseconds, while the error loop typically operates over a longer period, e.g., seconds.

Examples of the present technology pertain to improvement in the error microphone(s) 108 subsystem that can yield cost reduction and/or enhanced performance. As described above, existing ANC/RNC systems use discrete error microphone(s) 108 distributed throughout the cabin. Each microphone is packaged in its own module. Typically, four to eight error microphones 108 are required.

Examples of the present technology include at least one error microphone array unit consisting of at least two microphones packaged into a single module. In some examples, e.g., where two microphones are spaced less than or equal to one half of the wavelength of the highest frequency to be cancelled, beamforming can be performed. In some examples, virtual sensing (described below) is used.

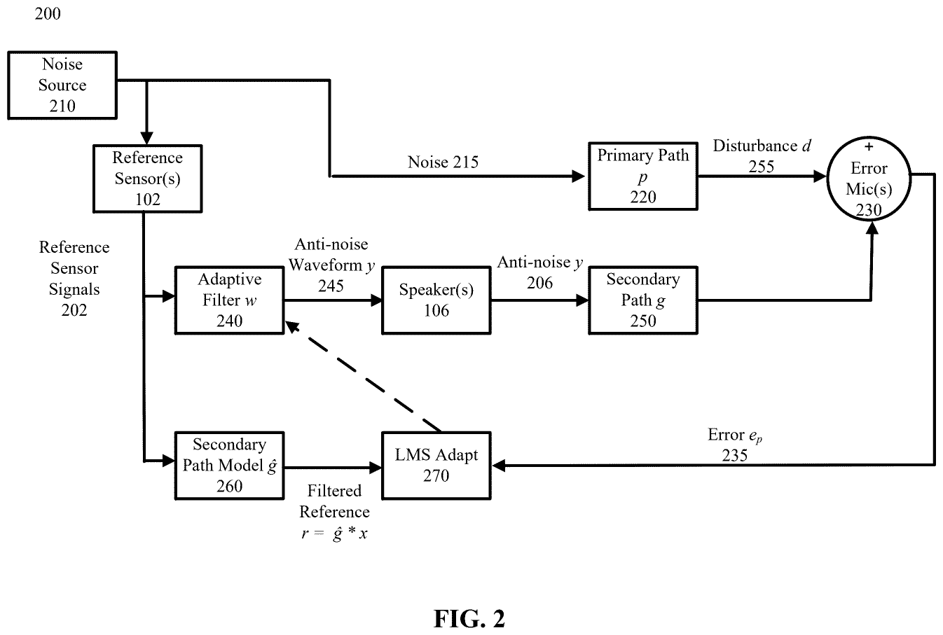

Referring to FIG. 2, and continuing to refer to FIG. 1 for context, a filtered reference least mean squares (FxLMS) approach 200 to ANC/RNC without virtual sensing is illustrated, in accordance with examples of the technology disclosed herein. In such an approach, noise source 210 creates noise 215 that propagates along a primary path p 220 as a disturbance d 255 at error microphone(s) 230. Noise 215 is also sensed by reference sensor(s) 102, which communicate reference sensor signal(s) 202 to adaptive filter w 240. Adaptive filter w 240 creates an anti-noise y waveform 245 and communicates the anti-noise y waveform 245 to speaker(s) 106 for transmission as anti-noise as anti-noise y 206 along secondary path g 250 to error microphone(s) 230.

Error microphone(s) 230 sense the combination of the disturbance d 255 and the anti-noise y 206 (as transformed/filtered by the secondary path g 250) to form error signal(s) eₚ 235. Adaptation function 270 uses error signal(s) eₚ 235 and the reference sensor signal(s) 202 (filtered by a secondary path model ĝ 260) to adjust the adaptive filter w 240. Typically, secondary path model ĝ 260 is derived during a calibration phase on a model of the operational environment.

One drawback of this approach is that the resulting quiet zone is focused on the location of the error microphone(s) 230. Typically, in part because of design and manufacturability constraints, error microphone(s) 230 are not located at the head positions of vehicle occupants.

Virtual sensing is a family of techniques to locate the quiet zone(s) closer to the anticipated head position(s) of the vehicle occupants, instead of at the error microphones. Examples of the technology disclosed herein can use remote microphone technique (RMT) virtual sensing, also known as RM-VS, or auxiliary filtering virtual sensing (AF-VS), also known as “additional filter method.”

In addition to the use of virtual sensing, examples of the technology disclosed herein use error microphone array units instead of discrete error microphone(s) 108. In an error microphone array unit, several microphones operate in tandem. Typically, the error microphone array unit is made up of omnidirectional microphones linked to a processor/DSP/computer that records and interprets the results into a coherent form. Given a fixed physical relationship in space between the different individual microphone transducer array elements, coherent DSP processing of the signals from each of the individual error microphone array elements can create one or more virtual microphones. Different algorithms permit the creation of virtual microphones with extremely complex virtual polar patterns, e.g., beamforming.

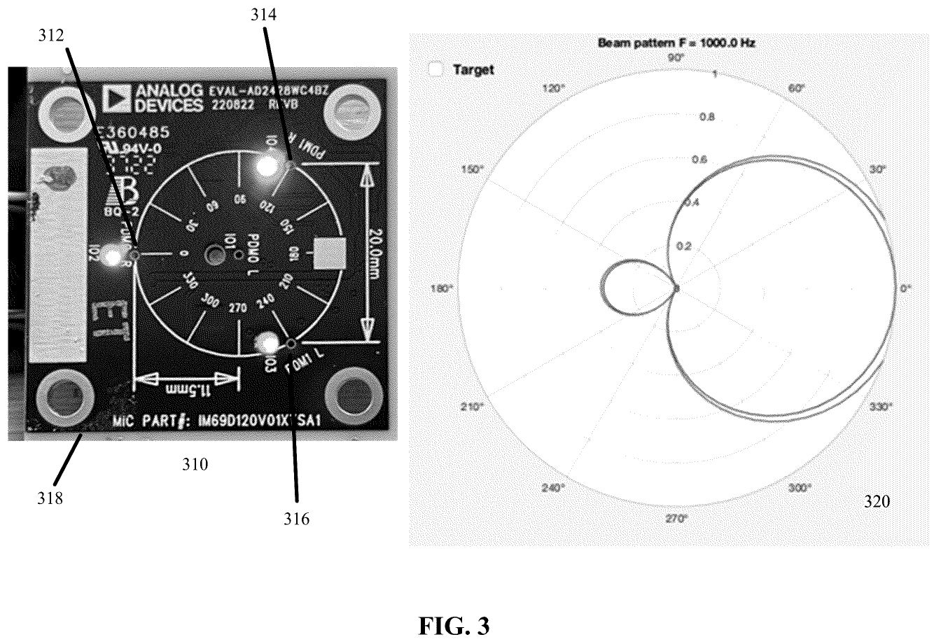

Referring to FIG. 3, and continuing to refer to prior figures for context, an example error microphone array unit 310 and an example polar pattern 320 derived from performing digital signal processing on the raw signals from the microphones is illustrated, in accordance with examples of the technology disclosed herein.

Example error microphone array unit 310 includes three (3) micro-electromechanical systems (MEMS) omnidirectional microphones—MEMS microphone 312, MEMS microphone 314, and MEMS microphone 316. The MEMS microphones are arranged in an equilateral triangle on a single printed circuit board 318. Additional circuitry on the reverse of the printed circuit board 318 (not shown) coherently captures signals from the three microphones. Example polar pattern 320 can be synthesized by combining the signals from the three MEMS error microphones. The example pattern 320 indicates that the combined signal will be primarily responsive to sounds arriving from the right (0 degrees), and to a lesser extent from the left (180 degrees), but that it will strongly attenuate sounds arriving from 120 degrees or 240 degrees.

Examples of the technology disclosed herein employ a plurality of error microphones per error microphone array unit 310. Such an approach can reduce the module count (a driver of cost in systems using ANC/RNC) while retaining performance—especially at higher frequencies of interest. In part because a plurality of microphones are integrated in the same unit, they may share auxiliary circuit elements, such as the codec for signal capture and conditioning, transceiver for sending digitized signals to the processor(s), control elements and power supply elements. In addition, the length of cabling to connect the full complement of error microphones in the vehicle to the processor may be reduced. Additionally, a processor (e.g., a DSP) may be provided within the error microphone unit to perform beamforming of the microphone signals on each unit.

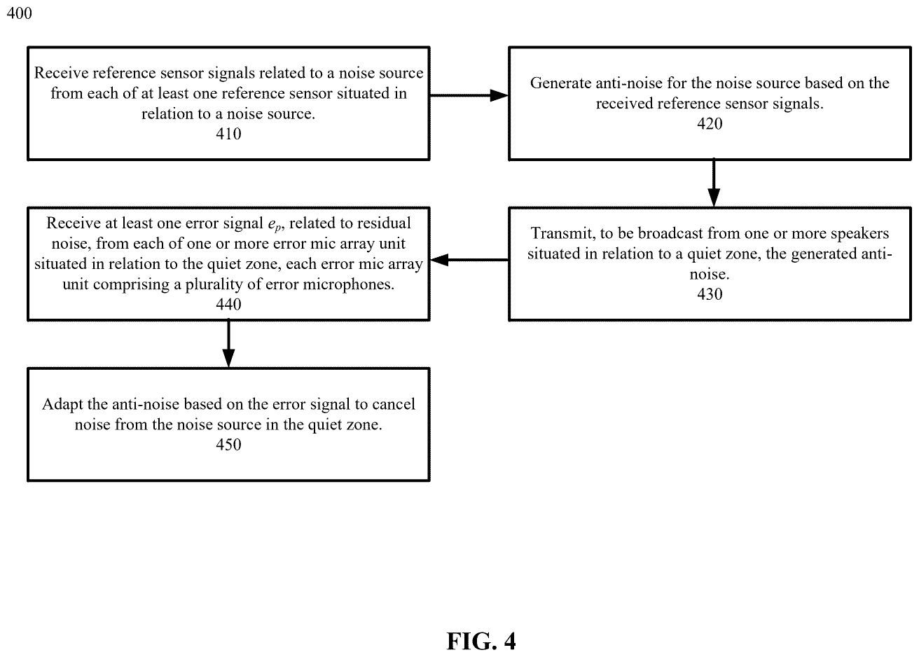

Referring to FIG. 4, and continuing to refer to prior figures for context, methods 400 for active noise cancellation are illustrated, in accordance with examples of the technology disclosed herein. In such methods 400 one or more processors receive reference sensor signals related to a noise source from each of at least one reference sensor situated in relation to a noise source—Block 410. In a continuing example, processor(s) 104 receive reference sensor signal(s) 202 gathered from noise sources (each wheel of a vehicle similar to the vehicle shown in FIG. 1) by reference sensor(s) 102.

In such methods 400, the processor(s) generate anti-noise for the noise source based on the received reference sensor signals—Block 420. In the continuing example, adaptive filter w 240 generates an anti-noise y waveform y 245.

In such methods 400, the processor(s) transmits the generated anti-noise to one or more speakers situated in relation to a quiet zone—Block 430. In the continuing example, processor(s) 104 transmit anti-noise waveform y 245 to speaker(s) 106 in the headliner and door posts of the vehicle. At least one of the speaker(s) 106 is placed in relation to the quiet zone of the head position of an expected driver, and outputs the anti-noise y 206 in that direction. In some examples, the door woofers and a subwoofer (if present, which is usually in the trunk area) are used.

In such methods 400, the processor(s) receive at least one error signal eₚ, related to residual noise, from each of one or more error microphone array unit(s) situated in relation to the quiet zone, each error microphone array unit comprising a plurality of error microphones—Block 440. In the continuing example, unlike in known approaches, one or more error microphone array units 310 are used—each error microphone array unit 310 including a plurality of error microphones (e.g., error microphone 312, error microphone 314, error microphone 316). The anti-noise y 206 propagates to the error microphone array unit 310 over a secondary path g 250. The noise 215 propagates to the error microphone array unit 310 over a primary path p 220 as disturbance d 255. Each error microphone array unit 310 combines disturbance d 255 and anti-noise y 206 (as filtered by the actual secondary path g 250) to form error signal eₚ 235.

In such methods 400, the processor(s) adapts the anti-noise based on the error signal to cancel noise from the noise source in the quiet zone—Block 450. In the continuing example, the processor(s) 104 use the filtered-reference LMS (FxLMS) adaptation function 270, which correlates i) the error signal eₚ 235 and ii) reference sensor signal(s) 202 filtered through a secondary path model ĝₚ 260 (modeled from each speaker to each error microphone array unit 310 during a calibration phase in a model environment), as described above, to adapt the weights used in adaptive filter w 240.

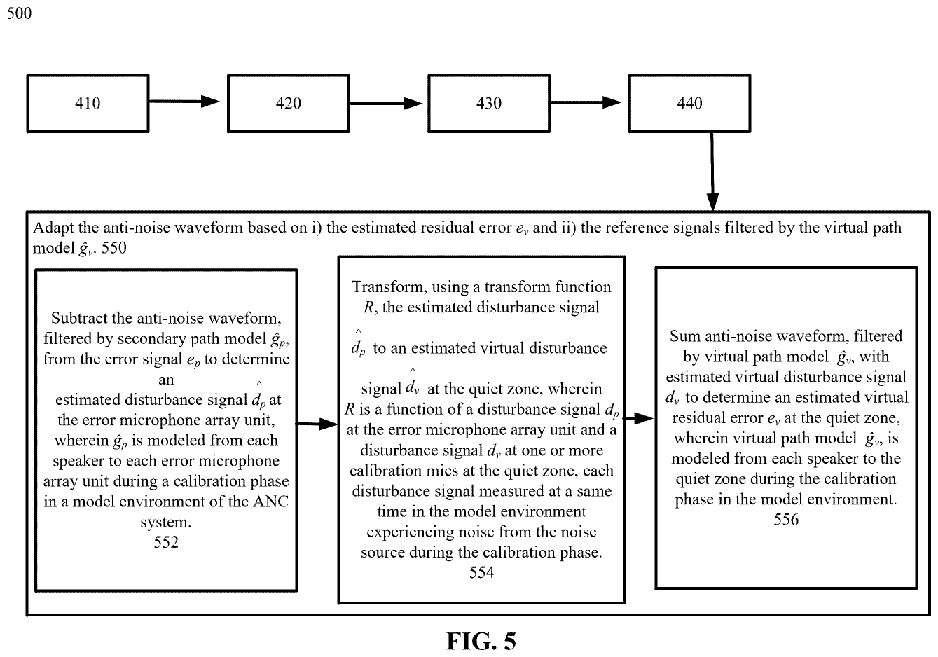

Referring to FIG. 5, and continuing to refer to prior figures for context, methods 500 for active noise cancellation are illustrated, in accordance with examples of the technology disclosed herein. In such methods 500, at least one error microphone array unit is situated outside the quiet zone. In such methods 500, Block 410, Block 420, Block 430, and Block 440 are performed as described elsewhere herein.

In such methods 500, adapting the anti-noise waveform based on the error signal to cancel noise from the noise source in the quiet zone includes adapting the anti-noise waveform based on i) the estimated residual error êᵥ and ii) the reference signals filtered by a virtual path model ĝᵥ.—Block 550

In such methods 500, the use of virtual sensing in adapting the anti-noise comprises the use of remote microphone technique (RMT). After receiving at least one error signal eₚ, related to residual noise, from each of one or more error microphone array unit situated in relation to the quiet zone, each error microphone array unit comprising a plurality of error microphones, the processor(s) subtract the anti-noise waveform, filtered by a secondary path model ĝₚ, from the error signal eₚ to determine an estimated disturbance signal \hat{d}ₚ at the error microphone array unit—Block 552. The secondary path model ĝₚ is modelled from each speaker to each error microphone array unit 310 during a calibration phase (described elsewhere herein) in a model environment of the ANC system.

In such methods 500, the processor(s) transform, using a transform function R (or equivalent time-domain filter bank r) the estimated disturbance signal \hat{d}ₚ to an estimated virtual disturbance signal \hat{d}ᵥ at the quiet zone—Block 554. The transfer function R (or filter r) is a function of i) a disturbance signal dₚ at the error microphone array unit and ii) a disturbance signal dᵥ at one or more calibration microphones at the quiet zone, each disturbance signal measured at a same time in the model environment experiencing noise from the noise source during the calibration phase (described elsewhere herein) in the model of the ANC system.

In such methods 500, the processor(s) sum the anti-noise y waveform, filtered by a virtual path model ĝᵥ, with estimated virtual disturbance signal \hat{d}ᵥ to determine an estimated virtual residual error êᵥ at the quiet zone—Block 556. The virtual path model ĝᵥ is modelled from each speaker to the quiet zone during the calibration phase in the model environment.

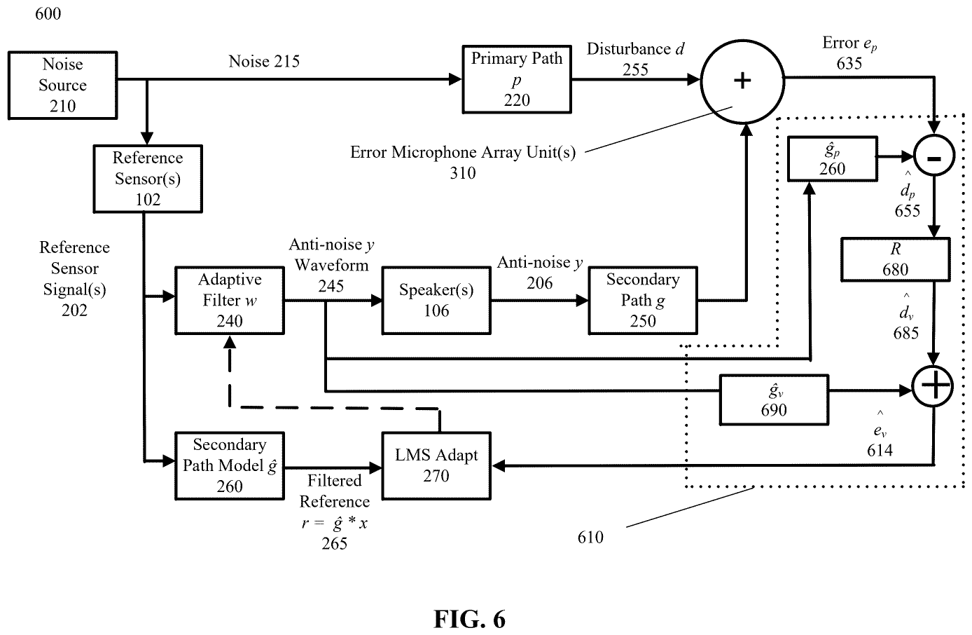

Referring to FIG. 6, and continuing to refer to prior figures for context, methods 600 for active noise cancellation using RMT is illustrated, in accordance with examples of the technology disclosed herein. In particular, methods 600 correspond to Block 550, Block 552, Block 554, and Block 556 of method 500 described above, along with dashed box 610 described below.

In Box 610, after receiving at least one error signal eₚ 635 related to residual noise, from each of one or more error microphone array unit 310 situated in relation to the quiet zone, the processor(s) subtract the anti-noise y waveform 245, filtered by a secondary path model ĝₚ 260, from the error signal eₚ 635 to determine an estimated disturbance signal \hat{d}ₚ 655 at the error microphone array unit 310.

The processor(s) then transform, using a transform function R 680, the estimated disturbance signal \hat{d}ₚ 655 (at the error microphone array unit 310) to an estimated virtual disturbance signal \hat{d}ᵥ 685 at the quiet zone. The processor(s) then sum the anti-noise y waveform 245, filtered by a virtual path model ĝᵥ 690, with estimated virtual disturbance signal \hat{d}ᵥ 685 to determine an estimated virtual residual error êᵥ 614 at the quiet zone. The estimated virtual residual error êᵥ 614 is then used as described above by the LMS adaptation function 270 to adapt filter w 240.

As noted above, during a calibration phase in a model environment of the ANC system (e.g., a vehicle) without running an ANC system: secondary path model ĝₚ is modelled from each speaker 106 to each error microphone array unit 310; disturbance signal dₚ (at the error microphone array unit 310) and a disturbance signal dᵥ (at one or more calibration microphones at the quiet zone) are measured coherently: R is determined as a function dₚ and dᵥ; and virtual path model ĝᵥ is modelled from each speaker 106 to the calibration microphones at the quiet zone.

The RMT transfer function R (or filter bank r) produces the best (in the least-squares sense) prediction of what would be measured at the virtual (quiet-zone) microphones, based on what is measured at the error microphone array units 310 (or error beams in the case of beamforming preprocessing). One method for performing calibration for RMT includes, installing temporary calibration microphones at the virtual microphone positions in the desired quiet zone. This method further includes, while the noise source is active, (e.g., for road noise cancellation, driving the vehicle on representative road surfaces), make synchronized recordings of the disturbance signals at all error microphone array units (dₚ) and all temporary calibration microphones (dᵥ). This method further includes, if beamforming is to be used, applying beamforming transformation (b) to the recorded error microphone array signals.

Linear regression can be used to find the transfer function R via least-squares fit in the frequency domain using the following equations, where λ is a regularization parameter to avoid overfitting:

$$R = arg min {‖ {D}_{v} - R {D}_{p} ‖}^{2} + λ {‖ R ‖}^{2} \qquad ( 1 )$$

$${R}^{H} = {( {D}_{p} {D}_{p}^{H} + λ I )}^{- 1} ( {D}_{p} {D}_{v}^{H} ) \qquad ( 2 )$$

If time-domain RMT coefficients are required, inverse fast Fourier transform (FFT) of R can be used to recover them.

Another method is to directly estimate, via ordinary least squares regression, the set of time-domain coefficients \hat{r} that best predict the temporary calibration microphone signals (dᵥ) from a linear combination of the (beamformed) error microphone signals (b*dₚ), e.g., per Equation (3)

$$\hat{r} = arg {min}_{r} {‖ {d}_{v} - r * b * {d}_{p} ‖}^{2} \qquad ( 3 )$$

In general, if the number error microphones is greater than or equal to the number of sound source directions (e.g., the number of wheels in a vehicle), then the RMT least-squares fit effectively unmixes the errors back to the sources and remixes for the virtual (quiet-zone) microphone positions. If the sound field is purely modal, and the number of error microphones is greater than or equal to the number of overlapping modes, then it can be said that that RMT least-squares fit is decomposing the disturbance sound field into modes and spatially interpolating those modes to the virtual (quiet-zone) microphone positions.

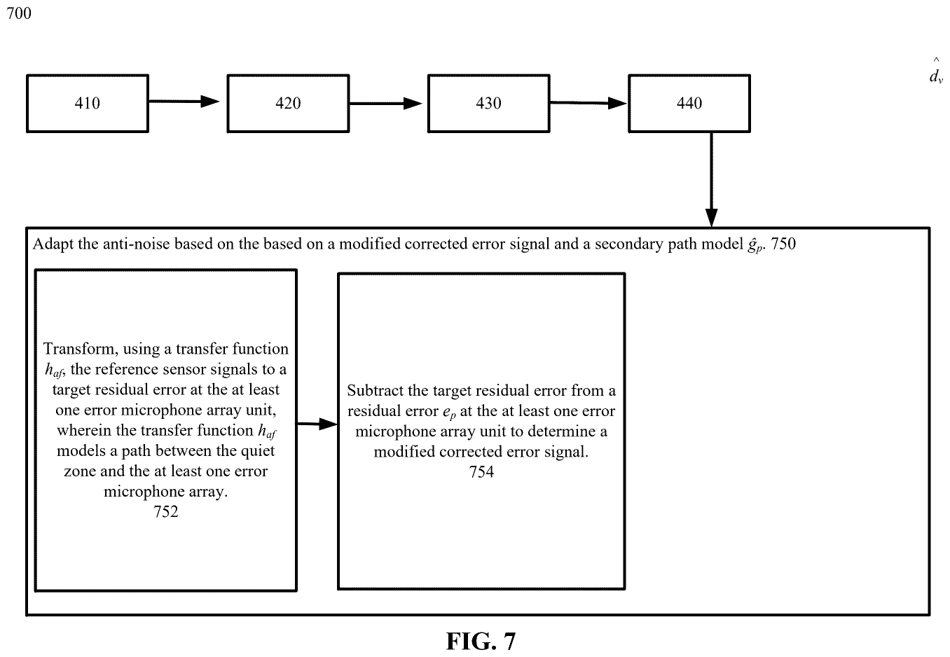

Referring to FIG. 7, and continuing to refer to prior figures for context, methods 700 for active noise cancellation are illustrated, in accordance with examples of the technology disclosed herein. In such methods 700, at least one error microphone array unit is situated outside the quiet zone. In such methods 700, Block 410, Block 420, Block 430, and Block 440 are performed as described elsewhere herein.

In such methods 700, adapting the anti-noise is based on virtual sensing that infers the difference between the noise in the quiet zone and the error signals from each error microphone array unit situated outside the quiet zone—Block 750. In such methods 700, the use of virtual sensing in adapting the anti-noise comprises the use of auxiliary filtering virtual sensing (AF-VS) based on a modified corrected error signal and a secondary path model ĝₚ.

In such methods 700, the processor(s) transform, using an auxiliary filter h_{af}, the reference sensor signals to a target residual error at the at least one error microphone array unit—Block 752. The auxiliary filter h_{af} models a target residual noise at least one error microphone array that can be predicted from the reference signals—and is determined during a calibration phase (described below).

In such methods 700, the processor(s) subtracts the target residual error from a residual error eₚ at the at least one error microphone array unit to determine the modified corrected error signal—Block 754.

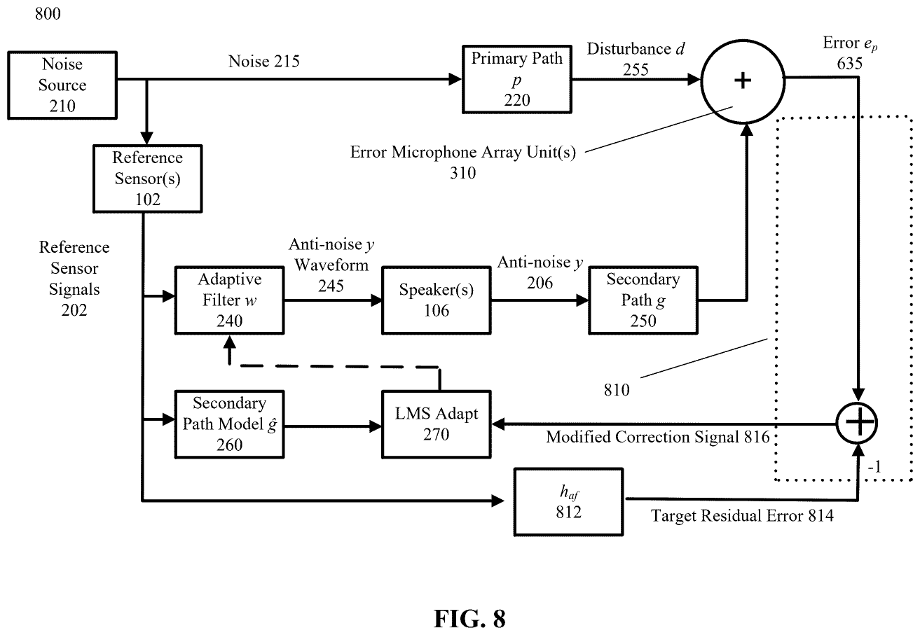

Referring to FIG. 8, and continuing to refer to prior figures for context, methods 800 for active noise cancellation using AF-VS are illustrated, in accordance with examples of the technology disclosed herein. In particular, methods 800 described below correspond to Block 550, Block 552, Block 554, and Block 556 of method 500 along with dashed box 810.

After receiving at least one error signal eₚ 635 related to residual noise, from each of one or more error microphone array unit 310 situated in relation to the quiet zone, the processor(s) subtract the target residual error 814 at the error microphone array unit 310 (derived from the transfer function h_{af} 812 determined during a calibration phase) from error signal eₚ 635 to for a modified correction signal 816. The inputs to the adaptation function 270 are the modified correction signal and the reference signals filtered through the secondary path model ĝₚ.

During the calibration phase for AF-VS, the secondary path model ĝₚ is determined as described above. The auxiliary filter hₐ can be determined in several ways, including using an online LMS-based process for determining auxiliary filters, e.g., as described in Shi et al 2020 paper.

In some examples, temporary calibration microphones are installed at the virtual microphone positions in the desired quiet zone. In such examples, the secondary path models are calibrated to the temporary calibration microphones. Such calibration may include, while the noise source is active, (e.g., for road noise cancellation, driving the vehicle on representative road surfaces), and running the adaptive ANC algorithm, with adaptation based on the residual error at the temporary calibration microphone (eᵥ) and the virtual secondary path models (gᵥ). Such calibration may further include coherently recording the reference signals (x) and the residual signals at the error microphone array units (eₚ) while the ANC system is operating. If beamforming is to be used, such calibration may further include applying beamforming transformation (b) to the recorded error microphone array signals. Such calibration may subsequently include estimating, via ordinary least squares regression, the set of coefficients ĥ that best predict the (beamformed) residual error microphone signals from a linear combination of the reference signals per Equation (4).

$$\hat{h} = arg {min}_{h} {‖ b * {e}_{p} - h * x ‖}^{2} \qquad ( 4 )$$

Another method for determining the auxiliary filter h_{af} is performed by using simulation of FxLMS with virtual microphone feedback. The method continues by performing a least-squares regression to solve the following equation, where h=auxiliary filter coefficients to be determined, \tilde{e}ᵣ=residual errors observed at the error mics during the simulation, and xᵣ=reference signals from the on-road recording

$$h = arg {min}_{h} {\sum }_{r = 0}^{R - 1} {\sum }_{m} {‖ {\tilde{e}}_{r} - h * {x}_{r} ‖}^{2} \qquad ( 5 )$$

The secondary path models [symbol] and [symbol] can be determined as follows. An impulse response duration to be modeled is selected. An exemplary value for an indoor or vehicle acoustic environment may be 100 ms. The product of the sampling rate (e.g., 2 kHz) and the impulse response duration (100 ms) determines the number of filter coefficients (200) that will be used for each secondary path model.

For calibrating [symbol] and [symbol] , temporary calibration microphones may be installed at the virtual microphone positions in the desired quiet zone. A stimulus waveform (y) may be generated and stored in computer memory with a flat power spectral density over the frequency range to be addressed by the ANC system. An example stimulus waveform is a chirp.

For each speaker, in turn: the stimulus waveform (y) may be played from the speaker, while recording the signals received by each microphone (dₚ or dᵥ); then, via least-mean squares algorithm or ordinary least squares regression, a set of filter coefficients that model the secondary path from the loudspeaker to each microphone may be estimated, e.g., as shown in Equation (6) and Equation (7).

$$= arg {min}_{{g}_{p}} {‖ {d}_{p} - {g}_{p} * y ‖}^{2} \qquad ( 6 )$$

$$= arg {min}_{{g}_{v}} {‖ {d}_{v} - {g}_{v} * y ‖}^{2} \qquad ( 7 )$$

In some examples, at least one combination of two error microphones (e.g., microphone 312 and microphone 314) of at least one error microphone array unit 310 are spaced apart less than or equal to one half of a wavelength of a highest frequency noise to be cancelled by the ANC system. In some such methods 400, the anti-noise y 206 is responsive to cancel noise of frequency less than 500 Hz.

In some examples, the processor(s) are further configured to execute instructions to beamform a function of the error signal eₚ from each error microphone array unit 310 to form a null in an estimated direction of a sound source other than the noise source 210.

In such examples, two or more error microphones (e.g., microphone 312 and microphone 314) within a single error microphone array unit 310 are spaced at distance d<λₘᵢₙ/2, where λₘᵢₙ is the wavelength corresponding to the highest frequency (smallest wavelength) sound to be cancelled by RNC (e.g. 500 Hz=>λₘᵢₙ=68 cm, λₘᵢₙ/2=34 cm). Samples from each appropriately spaced microphone (e.g., microphone 312 and microphone 314) in the error microphone array unit 310 are captured in a phase/time coherent manner (simultaneously). Mics within an error microphone array unit 310 are well-matched in gain (phase and amplitude) characteristics, or differences between them have been calibrated. For closely spaced mics (d much less than λ/2), low self-noise (high SNR) microphones may be required. The processor(s) 104 are configured to receive the signals from individual mics and combine them using a bank of digital filters, which implement beamforming.

For closely spaced error microphones (d<<λ/2), the error signals captured by the individual microphones may be highly correlated. Using several highly correlated inputs to a virtual sensing processing (e.g., RMT) can lead to overfitting at the time of calibration. If the RMT transfer functions are overfit, this may cause the system to be highly sensitive to changes in the cabin acoustic environment or microphone response (e.g., from changes in passenger occupancy or luggage loading) and may lead to degraded performance of the RNC system during operation. This problem can be mitigated by designing a set of beamforming coefficients that produce decorrelated error signals from the correlated individual microphone signals.

In some examples, the RNC system does not attempt to cancel speech. In vehicles with poor isolation between cabin and exterior, some speech may be picked up by the reference sensor(s) 102. Incidental (random) correlations between the speech and reference sensor signal(s) 202 may also occur. Either of these cases can lead to degraded performance in cancelling road noise unless means are provided to exclude speech from the adaptation signal. If speech is present in the data used for calibrating the virtual sensing transfer functions (R for RMT, h for AF), beamforming processing can be used to mitigate its contaminating effects. Some examples of the technology disclosed herein configure the beamforming transformation so that it nulls (attenuates) signal components coming from directions likely to include speech, or other sounds not to be cancelled.

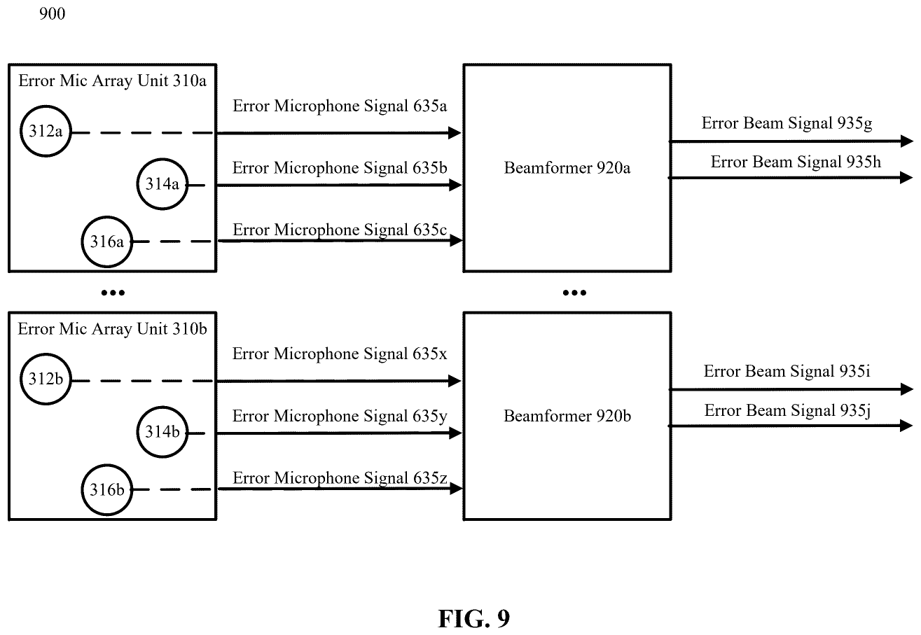

Referring to FIG. 9, and continuing to refer to prior figures for context, an example beamformer architecture 900 is illustrated, in accordance with examples of the technology disclosed herein. In architecture 900, a separate beamformer (e.g., beamformer 920a, beamformer 920b) is used for each error microphone array unit 310—signals captured in the same error microphone array unit 310 are processed together. In the example of FIG. 9 there are three error microphone signals (e.g., 635a, 635b, and 635c for error microphone array unit 310a) per module combined into two beams per module (e.g., error beam signal 935h, error beam signal 935h) by a beamformer (e.g., beamformer 920a).

While the example of FIG. 9 includes two error microphone array units 310 and two beamformers 920, other examples can include only one of each, while yet other examples can include less beamformers. It is not required for each module to have the same arrangement of beams, or even the same number of microphones or beams. In some examples, all beam signals are aggregated at the end for downstream processing (either RMT or AF-VS).

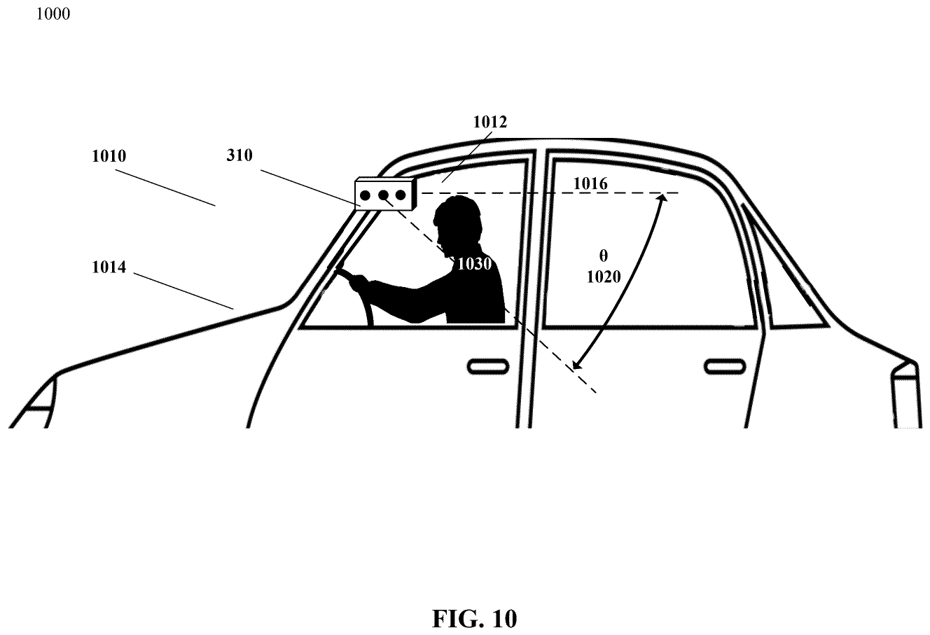

FIG. 10 illustrates an arrangement 1000 for beamforming at an error microphone array module to mitigate interference from speech by vehicle occupants, in accordance with examples of the technology disclosed herein. A linear error microphone array unit 310 is shown installed in the headliner 1012 above the A-pillar 1014 of a vehicle 1010. The polar angle 1020 from the array axis 1016 to the typical position of the nearest occupant 1030 is indicated by θ. A set of beamformer coefficients is selected to attenuate signals arriving from the direction θ. Each module in the vehicle 1010 could be similarly configured to attenuate speech from the nearest occupant 1030. Speech picked up from other occupants seated further would be much lower in magnitude and would naturally cause less interference to the operation of RNC than speech from the nearest passenger.

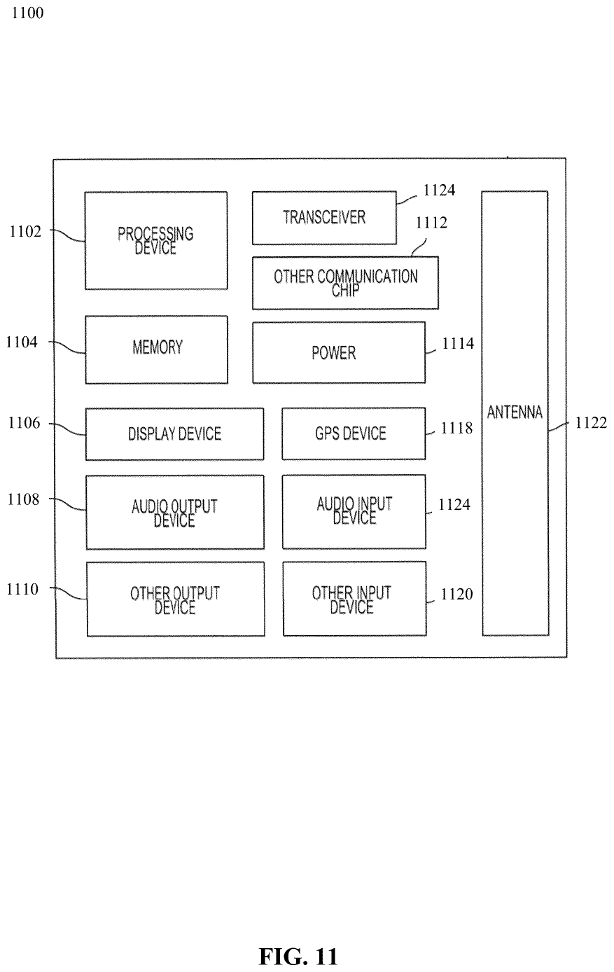

Examples of the present disclosure may be implemented into a system using any suitable hardware and/or software to configure as desired. Referring to FIG. 11, and continuing to refer to prior figures for context, FIG. 11 schematically illustrates a device 1100 that may serve as a computer/processor, in accordance with various examples. A number of components are illustrated in FIG. 11 as included in the device 1100, but any one or more of these components may be omitted or duplicated, as suitable for the application.

Additionally, in various examples, the device 1100 may not include one or more of the components illustrated in FIG. 11, but the device 1100 may include interface circuitry for coupling to the one or more components. For example, the device 1100 may not include a display device 1106, but may include display device interface circuitry (e.g., a connector and driver circuitry) to which a display device 1106 may be coupled. In another set of examples, the device 1100 may not include an audio input device 1124 or an audio output device 1108 but may include audio input or output device interface circuitry (e.g., connectors and supporting circuitry) to which an audio input device 1124 or audio output device 1108 may be coupled.

The device 1100 may include a transceiver 1124, in accordance with any of the examples disclosed herein, for managing communication along the bus when the device 1100 is coupled to the bus. The device 1100 may include a processing device 1102 (e.g., one or more processing devices), which may be included in the node transceiver or separate from the node transceiver. As used herein, the term “processing device” may refer to any device or portion of a device that processes electronic data from registers and/or memory to transform that electronic data into other electronic data that may be stored in registers and/or memory. The processing device 1102 may include one or more DSPs, ASICs, central processing units (CPUs), graphics processing units (GPUs), crypto-processors, or any other suitable processing devices. The device 1100 may include a memory 1104, which may itself include one or more memory devices such as volatile memory (e.g., dynamic random-access memory (DRAM)), non-volatile memory (e.g., read-only memory (ROM)), flash memory, solid state memory, and/or a hard drive.

In some examples, the memory 1104 may be employed to store a working copy and a permanent copy of programming instructions to cause the device 1100 to perform any suitable ones of the techniques disclosed herein. In some examples, machine-accessible media (including non-transitory computer-readable storage media), methods, systems, and devices for performing the above-described techniques are illustrative examples disclosed herein for communication over a two-wire bus. For example, a computer-readable media (e.g., the memory 1104) may have stored thereon instructions that, when executed by one or more of the processing devices included in the processing device 1102, cause the device 1100 to perform any of the techniques disclosed herein.

In some examples, the device 1100 may include another communication chip 1112 (e.g., one or more other communication chips). For example, the communication chip 1112 may be configured for managing wireless communications for the transfer of data to and from the device 1100. The term “wireless” and its derivatives may be used to describe circuits, devices, systems, methods, techniques, communications channels, etc., that may communicate data using modulated electromagnetic radiation through a non-solid medium. The term does not imply that the associated devices do not contain any wires, although in some examples they might not.

The communication chip 1112 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The one or more communication chips 1112 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The one or more communication chips 1112 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The one or more communication chips 1112 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1112 may operate in accordance with other wireless protocols in other examples. The device 1100 may include an antenna 1122 to facilitate wireless communications and/or to receive other wireless communications (such as AM or FM radio transmissions).

In some examples, the communication chip 1112 may manage wired communications using a protocol other than the protocol for the bus described herein. Wired communications may include electrical, optical, or any other suitable communication protocols. Examples of wired communication protocols that may be enabled by the communication chip 1112 include Ethernet, controller area network (CAN), I2C, media-oriented systems transport (MOST), or any other suitable wired communication protocol.

As noted above, the communication chip 1112 may include multiple communication chips. For instance, a first communication chip 1112 may be dedicated to shorter-range wireless communications such as Wi-Fi or Bluetooth, and a second communication chip 1112 may be dedicated to longer-range wireless communications such as global positioning system (GPS), EDGE, GPRS, CDMA, WiMAX, LTE, EV-DO, or others. In some examples, a first communication chip 1112 may be dedicated to wireless communications, and a second communication chip 1112 may be dedicated to wired communications.

The device 1100 may include battery/power circuitry 1114. The battery/power circuitry 1114 may include one or more energy storage devices (e.g., batteries or capacitors) and/or circuitry for coupling components of the device 1100 to an energy source separate from the device 1100 (e.g., AC line power, voltage provided by a car battery, etc.). For example, the battery/power circuitry 1114 may include the upstream bus interface circuitry and the downstream bus interface circuitry discussed above with reference to FIG. 2 and could be charged by the bias on a bus.

The device 1100 may include a display device 1106 (or corresponding interface circuitry, as discussed above). The display device 1106 may include any visual indicators, such as a heads-up display, a computer monitor, a projector, a touchscreen display, a liquid crystal display (LCD), a light-emitting diode display, or a flat panel display, for example.

The device 1100 may include an audio output device 1108 (or corresponding interface circuitry, as discussed above). The audio output device 1108 may include any device that generates an audible indicator, such as speakers, headsets, or earbuds, for example.

The device 1100 may include an audio input device 1124 (or corresponding interface circuitry, as discussed above). The audio input device 1124 may include any device that generates a signal representative of a sound, such as microphones, microphone arrays, or digital instruments (e.g., instruments having a musical instrument digital interface (MIDI) output).

The device 1100 may include a GPS device 1118 (or corresponding interface circuitry, as discussed above). The GPS device 1118 may be in communication with a satellite-based system and may receive a location of the device 1100, as known in the art.

The device 1100 may include another output device 1110 (or corresponding interface circuitry, as discussed above). Examples of the other output device 1110 may include an audio codec, a video codec, a printer, a wired or wireless transmitter for providing information to other devices, or an additional storage device. Additionally, any suitable ones of the peripheral devices may be included in the other output device 1110.

The device 1100 may include another input device 1120 (or corresponding interface circuitry, as discussed above). Examples of the other input device 1120 may include an accelerometer, a gyroscope, an image capture device, a keyboard, a cursor control device such as a mouse, a stylus, a touchpad, a bar code reader, a Quick Response (QR) code reader, or a radio frequency identification (RFID) reader. Additionally, any suitable ones of the sensors or peripheral devices may be included in the other input device 1120.

Any suitable ones of the display, input, output, communication, or memory devices described above with reference to the device 1100 may serve as the peripheral device in system of the technology disclosed herein. Alternatively or additionally, suitable ones of the display, input, output, communication, or memory devices described above with reference to the device 1100 may be included in a host or a node (e.g., a main node or a sub node).

Having thus described several aspects and examples of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the examples described herein.

Those skilled in the art will recognize or be able to ascertain using no more than routine experimentation, many equivalents to the specific examples described herein. It is, therefore, to be understood that the foregoing examples are presented by way of example only and that, within the scope of the appended claims and equivalents thereto, inventive examples may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The foregoing outlines features of one or more examples of the subject matter disclosed herein. These examples are provided to enable a person having ordinary skill in the art (PHOSITA) to better understand various aspects of the present disclosure. Certain well-understood terms, as well as underlying technologies and/or standards may be referenced without being described in detail. It is anticipated that the PHOSITA will possess or have access to background knowledge or information in those technologies and standards sufficient to practice the teachings of the present disclosure.

The PHOSITA will appreciate that they may readily use the present disclosure as a basis for designing or modifying other processes, structures, or variations for carrying out the same purposes and/or achieving the same advantages of the examples introduced herein. The PHOSITA will also recognize that such equivalent constructions do not depart from the spirit and scope of the present disclosure, and that they may make various changes, substitutions, and alterations herein without departing from the spirit and scope of the present disclosure.

The above-described examples may be implemented in any of numerous ways. One or more aspects and examples of the present application involving the performance of processes or methods may utilize program instructions executable by a device (e.g., a computer, a processor, or other device) to perform, or control performance of, the processes or methods.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various examples described above.

The computer readable medium or media may be transportable, such that the program or programs stored thereon may be loaded onto one or more different computers or other processors to implement various ones of the aspects described above. In some examples, computer readable media may be non-transitory media.

Note that the activities discussed above with reference to the FIGURES which are applicable to any integrated circuit that involves signal processing (for example, gesture signal processing, video signal processing, audio signal processing, analog-to-digital conversion, digital-to-analog conversion), particularly those that can execute specialized software programs or algorithms, some of which may be associated with processing digitized real-time data.

In some cases, the teachings of the present disclosure may be encoded into one or more tangible, non-transitory computer-readable mediums having stored thereon executable instructions that, when executed, instruct a programmable device (such as a processor or DSP) to perform the methods or functions disclosed herein. In cases where the teachings herein are embodied at least partly in a hardware device (such as an ASIC, IP block, or SoC), a non-transitory medium could include a hardware device hardware-programmed with logic to perform the methods or functions disclosed herein. The teachings could also be practiced in the form of Register Transfer Level (RTL) or other hardware description language such as VHDL or Verilog, which can be used to program a fabrication process to produce the hardware elements disclosed.

In example implementations, at least some portions of the processing activities outlined herein may also be implemented in software. In some examples, one or more of these features may be implemented in hardware provided external to the elements of the disclosed figures, or consolidated in any appropriate manner to achieve the intended functionality. The various components may include software (or reciprocating software) that can coordinate in order to achieve the operations as outlined herein. In still other examples, these elements may include any suitable algorithms, hardware, software, components, modules, interfaces, or objects that facilitate the operations thereof.

Any suitably configured processor component can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, an FPGA, an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, processors may store information in any suitable type of non-transitory storage medium (for example, random access memory (RAM), read only memory (ROM), FPGA, EPROM, electrically erasable programmable ROM (EEPROM), etc.), software, hardware, or in any other suitable component, device, element, or object where appropriate and based on particular needs. Further, the information being tracked, sent, received, or stored in a processor could be provided in any database, register, table, cache, queue, control list, or storage structure, based on particular needs and implementations, all of which could be referenced in any suitable timeframe.

Any of the memory items discussed herein should be construed as being encompassed within the broad term ‘memory.’ Similarly, any of the potential processing elements, modules, and machines described herein should be construed as being encompassed within the broad term ‘microprocessor’ or ‘processor.’ Furthermore, in various examples, the processors, memories, network cards, buses, storage devices, related peripherals, and other hardware elements described herein may be realized by a processor, memory, and other related devices configured by software or firmware to emulate or virtualize the functions of those hardware elements.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a personal digital assistant (PDA), a smart phone, a mobile phone, an iPad, or any other suitable portable or fixed electronic device.

Also, a computer may have one or more input and output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Computer-executable instructions may be in many forms, such as program modules, executed by one or more computers or other devices. Generally, program modules include routines, programs, objects, components, data structures, etc. that performs particular tasks or implement particular abstract data types. Typically, the functionality of the program modules may be combined or distributed as desired in various examples.

The terms “program” or “software” are used herein in a generic sense to refer to any type of computer code or set of computer-executable instructions that may be employed to program a computer or other processor to implement various aspects as described above. Additionally, it should be appreciated that according to one aspect, one or more computer programs that when executed perform methods of the present application need not reside on a single computer or processor, but may be distributed in a modular fashion among a number of different computers or processors to implement various aspects of the present application.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code may be executed on any suitable processor or collection of processors, whether provided in a single computer or distributed among multiple computers.

Computer program logic implementing all or part of the functionality described herein is embodied in various forms, including, but in no way limited to, a source code form, a computer executable form, a hardware description form, a computer-implemented method with memory storing code/instructions therein, and various intermediate forms (for example, mask works, or forms generated by an assembler, compiler, linker, or locator). In an example, source code includes a series of computer program instructions implemented in various programming languages, such as an object code, an assembly language, or a high-level language such as OpenCL, RTL, Verilog, VHDL, Fortran, C, C++, JAVA, or HTML for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

In some examples, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc.

Other components such as external storage, additional sensors, controllers for audio/video display, and peripheral devices may be attached to the board as plug-in cards, via cables, or integrated into the board itself. In another example, the electrical circuits of the FIGURES may be implemented as standalone modules (e.g., a device with associated components and circuitry configured to perform a specific application or function) or implemented as plug-in modules into application-specific hardware of electronic devices.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this disclosure.

In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Also, as described, some aspects may be embodied as one or more methods. The acts performed as part of the method may be ordered in any suitable way. Accordingly, examples may be constructed in which acts are performed in an order different than illustrated, which may include performing some acts simultaneously, even though shown as sequential acts in illustrative examples.

### Additional Examples

In Example #1, the techniques described herein relate to an active noise cancellation (ANC) system, including: at least one reference sensor; at least one speaker; at least one error microphone array unit, each error microphone array unit including at least two error microphones; a memory storing instructions therein; and one or more processors: communicatively coupled with i) the memory, ii) each reference sensor, iii) each speaker, and iv) each error microphone array unit; and configured to execute the instructions to: receive reference sensor signals related to a noise source from each reference sensor situated in relation to the noise source; generate anti-noise for the noise source based on the received reference sensor signals; transmit the generated anti-noise from the speaker situated in relation to a quiet zone; receive at least one error signal, related to residual noise, from each error microphone array unit situated in relation to the quiet zone; and adapt the anti-noise based on the error signal to cancel noise from the noise source in the quiet zone.

In Example #2, in addition to Example #1, the techniques described herein relate to an ANC system, wherein at least one combination of two error microphones of at least one error microphone array unit are spaced apart less than or equal to one half of a wavelength of a highest frequency noise to be cancelled by the ANC system.

In Example #3, in addition to and one of Example #1-Example #2, the techniques described herein relate to a ANC system, wherein one or more processors are further configured to execute the instructions to beamform a function of the error signals from each error microphone array unit to form a null in an estimated direction of a sound source other than the noise source.

In Example #4, in addition to and one of Example #1-Example #3, the techniques described herein relate to an ANC system, wherein the sound source other than the noise source is a person. In Example #5, in addition to and one of Example #1-Example #4, the techniques described herein relate to an ANC system, wherein the anti-noise is responsive to cancel noise of frequency less than 500 Hz. In Example #6, in addition to and one of Example #1-Example #5, the techniques described herein relate to a ANC system, wherein: at least one error microphone array unit is situated outside the quiet zone; and adapting the anti-noise is based on virtual sensing that infers noise in the quiet zone based on the error signals from each error microphone array unit situated outside the quiet zone.

In Example #7, in addition to and one of Example #1-Example #6, the techniques described herein relate to an ANC system, wherein the virtual sensing includes remote microphone technique (RMT). In Example #8, in addition to and one of Example #1-Example #7, the techniques described herein relate to a ANC system, wherein: RMT includes: subtracting the anti-noise, filtered by a secondary path model, from the error signal to determine an estimated disturbance signal at the error microphone array unit, wherein is modeled from each speaker to each error microphone array unit during a calibration phase in a model environment of the ANC system; transforming, using a transform function R, the estimated disturbance signal to an estimated virtual disturbance signal at the quiet zone, wherein R is a function of i) a disturbance signal at the error microphone array unit and ii) a disturbance signal at one or more calibration microphones at the quiet zone, each disturbance signal measured at a same time in the model environment experiencing noise from the noise source during the calibration phase; and summing the anti-noise, filtered by a virtual path model, with estimated virtual disturbance signal to determine an estimated virtual residual error at the quiet zone, wherein virtual path model is modeled from each speaker to the quiet zone during the calibration phase in the model environment; and adapting the anti-noise includes adapting the anti-noise based on the estimated residual error and virtual path model.

In Example #9, in addition to and one of Example #1-Example #6, the techniques described herein relate to an ANC system, wherein the virtual sensing includes auxiliary filtering virtual sensing (AF-VS). In Example #10, in addition to and one of Example #1-Example #6 and Example #9, the techniques described herein relate to a ANC system, wherein: AF-VS includes: transforming, using a transfer function h_{af}, the reference sensor signals to a target residual error at the at least one error microphone array unit, wherein the transfer function h_{af}, models a path between the quiet zone and the at least one error microphone array; and subtracting the target residual error from a residual error eₚ at the at least one error microphone array unit to determine a modified corrected error signal; and adapting the anti-noise includes adapting the anti-noise based on the modified corrected error signal a secondary path model, wherein is modeled from each speaker to each error microphone array unit during a calibration phase in a model environment of the ANC system.

In Example #11, the techniques described herein relate to an active noise cancellation (ANC) method, including: receiving, in one or more processors, reference sensor signals related to a noise source from each of at least one reference sensor situated in relation to a noise source; generating, by the one or more processors, anti-noise for the noise source based on the received reference sensor signals; transmitting, by the one or more processors to one or more speakers to be broadcast from one or more speakers situated in relation to a quiet zone, the generated anti-noise; receiving, by the one or more processors, at least one error signal, related to residual noise, from each of one or more error microphone array unit situated in relation to the quiet zone, each error microphone array unit including a plurality of error microphones; and adapting, by the one or more processors, the anti-noise based on the error signal to cancel noise from the noise source in the quiet zone.

In Example #12, in addition to Example #11, the techniques described herein relate to an ANC method, wherein at least one combination of two error microphones of at least one error microphone array unit are spaced apart less than or equal to one half of a wavelength of a highest frequency noise to be cancelled by the method. In Example #13, in addition to any one of Example #11-Example #12, the techniques described herein relate to an ANC method, the method further includes: beamforming a function of the error signals from each error microphone array unit to form a null in an estimated direction of a sound source other than the noise source. In Example #14, in addition to and one of Example #11-Example #13, the techniques described herein relate to a ANC method, wherein: at least one error microphone array unit is situated outside the quiet zone; and adapting the anti-noise is based on virtual sensing that infers noise in the quiet zone based on the error signals from each error microphone array unit situated outside the quiet zone. In Example #15, in addition to and one of Example #11-Example #14, the techniques described herein relate to an ANC method, wherein the virtual sensing includes remote microphone technique (RMT).

In Example #16, in addition to and one of Example #11-Example #15, the techniques described herein relate to a ANC method, wherein: RMT includes: subtracting the anti-noise, filtered by a secondary path model, from the error signal to determine an estimated disturbance signal at the error microphone array unit, wherein is modeled from each speaker to each error microphone array unit during a calibration phase in a model environment; transforming, using a transform function R, the estimated disturbance signal to an estimated virtual disturbance signal at the quiet zone, wherein R is a function of i) a disturbance signal at the error microphone array unit and ii) a disturbance signal at one or more calibration microphones at the quiet zone, each disturbance signal measured at a same time in the model environment experiencing noise from the noise source during the calibration phase; and summing the anti-noise, filtered by a virtual path model, with estimated virtual disturbance signal to determine an estimated virtual residual error at the quiet zone, wherein virtual path model is modeled from each speaker to the quiet zone during the calibration phase in the model environment; and adapting the anti-noise includes adapting the anti-noise based on the estimated residual error and virtual path model.

In Example #17, in addition to any one of Example #11-Example #14, the techniques described herein relate to an ANC method, wherein the virtual sensing includes auxiliary filtering virtual sensing (AF-VS). In Example #18, in addition to any one of Example #11-Example #14 and Example #17, the techniques described herein relate to a ANC method, wherein: AF-VS includes: transforming, using a transfer function h_{af}, the reference sensor signals to a target residual error at the at least one error microphone array unit, wherein the transfer function h_{af} models a path between the quiet zone and the at least one error microphone array; and subtracting the target residual error from a residual error eₚ at the at least one error microphone array unit to determine a modified corrected error signal; and adapting the anti-noise includes adapting the anti-noise based on the modified corrected error signal a secondary path model, wherein is modeled from each speaker to each error microphone array unit during a calibration phase in a model environment of the method.

In Example #19, the techniques described herein relate to a non-transitory computer-readable medium storing computer executable instructions, the instructions when executed by one or more processors in a network is operative to: receive reference sensor signals related to a noise source from each of at least one reference sensor situated in relation to a noise source; generate, by the one or more processors, anti-noise for the noise source based on the received reference sensor signals; transmit, by the one or more processors to one or more speakers to be broadcast from one or more speakers situated in relation to a quiet zone, the generated anti-noise; receive, by the one or more processors, at least one error signal, related to residual noise, from each of one or more error microphone array unit situated in relation to the quiet zone, each error microphone array unit including a plurality of error microphones; and adapt, by the one or more processors, the anti-noise based on the error signal to cancel noise from the noise source in the quiet zone.

In Example #20, the techniques described herein relate to a vehicle, including: at least one reference sensor; at least one speaker; at least one error microphone array unit, each error microphone array unit including at least two error microphones; a memory storing instructions therein; and one or more processors: communicatively coupled with i) the memory, ii) each reference sensor, iii) each speaker, and iv) each error microphone array unit; and configured to execute the instructions to: receive reference sensor signals related to a noise source from each reference sensor situated in relation to the noise source; generate anti-noise for the noise source based on the received reference sensor signals; transmit the generated anti-noise from the speaker situated in relation to a quiet zone; receive at least one error signal, related to residual noise, from each error microphone array unit situated in relation to the quiet zone; and adapt the anti-noise based on the error signal to cancel noise from the noise source in the quiet zone . . . .

### INTERPRETATION OF TERMS

All definitions, as defined and used herein, should be understood to control over dictionary definitions, definitions in documents incorporated by reference, and/or ordinary meanings of the defined terms. Unless the context clearly requires otherwise, throughout the description and the claims: “comprise,” “comprising,” and the like are to be construed in an inclusive sense, as opposed to an exclusive or exhaustive sense; that is to say, in the sense of “including, but not limited to.” “Connected,” “coupled,” or any variant thereof, means any connection or coupling, either direct or indirect, between two or more elements. The coupling or connection between the elements can be physical, logical, or a combination thereof. “Herein,” “above,” “below,” and words of similar import, when used to describe this specification shall refer to this specification as a whole and not to any particular portions of this specification. “Or,” in reference to a list of two or more items, covers all of the following interpretations of the word: any of the items in the list, all of the items in the list, and any combination of the items in the list. The singular forms “a,” “an” and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/of” should be construed in the same fashion, i.e., “one or more” of the elements so conjoined.

Elements other than those specifically identified by the “and/or” clause may optionally be present, whether related or unrelated to those elements specifically identified. Thus, as a non-limiting example, a reference to “A and/or B”, when used in conjunction with open-ended language such as “comprising” may refer, in one example, to A only (optionally including elements other than B); in another example, to B only (optionally including elements other than A); in yet another example, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

Thus, as a non-limiting example, “at least one of A and B” (or, equivalently, “at least one of A or B,” or, equivalently “at least one of A and/or B”) may refer, in one example, to at least one, optionally including more than one, A, with no B present (and optionally including elements other than B); in another example, to at least one, optionally including more than one, B, with no A present (and optionally including elements other than A); in yet another example, to at least one, optionally including more than one, A, and at least one, optionally including more than one, B (and optionally including other elements); etc.

As used herein, the term “between” is to be inclusive unless indicated otherwise. For example, “between A and B” includes A and B unless indicated otherwise.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke 35 U.S.C. § 112(f) as it exists on the date of the filing hereof unless the words “means for” or “steps for” are specifically used in the particular claims; and (b) does not intend, by any statement in the disclosure, to limit this disclosure in any way that is not otherwise reflected in the appended claims.

The present invention should therefore not be considered limited to the particular examples described above. Various modifications, equivalent processes, as well as numerous structures to which the present invention may be applicable, will be readily apparent to those skilled in the art to which the present invention is directed upon review of the present disclosure.

It should be understood that the detailed description and specific examples, while indicating examples of the systems and methods are intended for purposes of illustration only and are not intended to limit the scope. These and other features, aspects, and advantages of the systems and methods of the present invention can be better understood from the description, appended claims or aspects, and accompanying drawings. It should be understood that the Figures are merely illustrative and are not drawn to scale. It should also be understood that the same reference numerals are used throughout the figures to indicate the same or similar parts.

Other variations to the disclosed examples can be understood and effected by those skilled in the art in practicing the disclosure, from a study of the drawings, the disclosure, and the appended aspects or claims. In the aspects or claims, the word “comprising” does not exclude other elements or steps, and the indefinite article “a” or “an” does not exclude a plurality. The mere fact that certain measures are recited in mutually different dependent aspects or claims does not indicate that a combination of these measures cannot be used to advantage. Any reference signs in the claims should not be construed as limited the scope.

What is claimed is:

1. An active noise cancellation (ANC) system, comprising:
at least one reference sensor;
at least one speaker;
at least one error microphone array unit, each error microphone array unit comprising at least two error microphones;
a memory storing instructions therein; and
one or more processors:
communicatively coupled with i) the memory, ii) each reference sensor, iii) each speaker, and iv) each error microphone array unit; and
configured to execute the instructions to:
receive reference sensor signals related to a noise source from each reference sensor situated in relation to the noise source;
generate an anti-noise for the noise source based on the received reference sensor signals;
transmit the generated anti-noise from the speaker situated in relation to a quiet zone;
receive at least one error signal eₚ, related to residual noise, from each error microphone array unit situated in relation to the quiet zone; and
adapt the anti-noise based on the error signal to cancel noise from the noise source in the quiet zone.

2. The ANC system of claim 1, wherein at least one combination of two error microphones of at least one error microphone array unit are spaced apart less than or equal to one half of a wavelength of a highest frequency noise to be cancelled by the ANC system.

3. The ANC system of claim 2, wherein one or more processors are further configured to execute the instructions to beamform a function of the error signals from each error microphone array unit to form a null in an estimated direction of a sound source other than the noise source.

4. The ANC system of claim 3, wherein the sound source other than the noise source is a person.

5. The ANC system of claim 1, wherein the anti-noise is responsive to cancel noise of frequency less than 500 Hz.

6. The ANC system of claim 1, wherein: at least one error microphone array unit is situated outside the quiet zone; and adapting the anti-noise is based on virtual sensing that infers noise in the quiet zone based on the error signals from each error microphone array unit situated outside the quiet zone.

7. The ANC system of claim 6, wherein the virtual sensing comprises remote microphone technique (RMT).

8. The ANC system of claim 7, wherein:
RMT comprises:
subtracting the anti-noise, filtered by a secondary path model ĝₚ, from the error signal eₚ to determine an estimated disturbance signal \hat{d}ₚ at the error microphone array unit, wherein ĝₚ is modeled from each speaker to each error microphone array unit during a calibration phase in a model environment of the ANC system;
transforming, using a transform function R, the estimated disturbance signal \hat{d}ₚ to an estimated virtual disturbance signal \hat{d}ᵥ at the quiet zone, wherein R is a function of i) a disturbance signal dₚ at the error microphone array unit and ii) a disturbance signal dᵥ at one or more calibration microphones at the quiet zone, each disturbance signal measured at a same time in the model environment experiencing noise from the noise source during the calibration phase; and
summing the anti-noise, filtered by a virtual path model ĝᵥ, with estimated virtual disturbance signal \hat{d}ᵥ to determine an estimated residual error êᵥ at the quiet zone, wherein virtual path model ĝᵥ is modeled from each speaker to the quiet zone during the calibration phase in the model environment; and
adapting the anti-noise comprises adapting the anti-noise based on the estimated residual error êᵥ and the reference signals filtered by virtual path model ĝᵥ.

9. The ANC system of claim 6, wherein the virtual sensing comprises auxiliary filtering virtual sensing (AF-VS).

10. The ANC system of claim 9, wherein:
AF-VS comprises:
transforming, using an auxiliary filter h_{af}, the reference sensor signals to a target residual error at the at least one error microphone array unit, wherein the auxiliary filter h_{af} models an expected signal at least one error microphone array when noise is cancelled within the quiet zone; and
subtracting the target residual error from a residual error eₚ at the at least one error microphone array unit to determine a modified corrected error signal; and
adapting the anti-noise comprises adapting the anti-noise based on the modified corrected error signal and reference signals filtered by a secondary path model ĝₚ, wherein ĝₚ is modeled from each speaker to each error microphone array unit during a calibration phase in a model environment of the ANC system.

11. An active noise cancellation (ANC) method, comprising:
receiving, in one or more processors, reference sensor signals related to a noise source from each of at least one reference sensor situated in relation to a noise source;
generating, by the one or more processors, an anti-noise waveform for the noise source based on the received reference sensor signals;
transmitting, by the one or more processors to one or more speakers to be broadcast from one or more speakers situated in relation to a quiet zone, the generated anti-noise waveform;
receiving, by the one or more processors, at least one error signal eₚ, related to residual noise, from each of one or more error microphone array unit situated in relation to the quiet zone, each error microphone array unit comprising a plurality of error microphones; and
adapting, by the one or more processors, the anti-noise waveform based on the error signal to cancel noise from the noise source in the quiet zone.

12. The ANC method of claim 11, wherein at least one combination of two error microphones of at least one error microphone array unit are spaced apart less than or equal to one half of a wavelength of a highest frequency noise to be cancelled by the method.

13. The ANC method of claim 12, the method further comprises:
beamforming a function of the error signals from each error microphone array unit to form a null in an estimated direction of a sound source other than the noise source.

14. The ANC method of claim 11, wherein: at least one error microphone array unit is situated outside the quiet zone; and adapting the anti-noise is based on virtual sensing that infers noise in the quiet zone based on the error signals from each error microphone array unit situated outside the quiet zone.

15. The ANC method of claim 14, wherein the virtual sensing comprises remote microphone technique (RMT).

16. The ANC method of claim 15, wherein:
RMT comprises:
subtracting the anti-noise waveform, filtered by a secondary path model ĝₚ, from the error signal eₚ to determine an estimated disturbance signal \hat{d}ₚ at the error microphone array unit, wherein ĝₚ is modeled from each speaker to each error microphone array unit during a calibration phase in a model environment;
transforming, using a transform function R, the estimated disturbance signal \hat{d}ₚ to an estimated virtual disturbance signal \hat{d}ᵥ at the quiet zone, wherein R is a function of i) a disturbance signal dₚ at the error microphone array unit and ii) a disturbance signal dᵥ at one or more calibration microphones at the quiet zone, each disturbance signal measured at a same time in the model environment experiencing noise from the noise source during the calibration phase; and
summing the anti-noise waveform, filtered by a virtual path model ĝᵥ, with estimated virtual disturbance signal \hat{d}ᵥ to determine an estimated residual error êᵥ at the quiet zone, wherein virtual path model ĝᵥ is modeled from each speaker to the quiet zone during the calibration phase in the model environment; and
adapting the anti-noise comprises adapting the anti-noise waveform based on i) the estimated residual error êᵥ and ii) reference signals filtered by virtual path model ĝᵥ.

17. The ANC method of claim 14, wherein the virtual sensing comprises auxiliary filtering virtual sensing (AF-VS).

18. The ANC method of claim 17, wherein:
AF-VS comprises:
transforming, using an auxiliary filter h_{af}, the reference sensor signals to a target residual error at the at least one error microphone array unit, wherein the auxiliary filter h_{af} models an expected signal at least one error microphone array when noise is cancelled within the quiet zone; and
subtracting the target residual error from a residual error eₚ at the at least one error microphone array unit to determine a modified corrected error signal; and
adapting the anti-noise comprises adapting the anti-noise based on the modified corrected error signal and reference signals filtered by a secondary path model ĝₚ, wherein ĝₚ is modeled from each speaker to each error microphone array unit during a calibration phase in a model environment of the method.

19. A non-transitory computer-readable medium storing computer executable instructions, the instructions when executed by one or more processors in a network is operative to:
receive reference sensor signals related to a noise source from each of at least one reference sensor situated in relation to a noise source;
generate, by the one or more processors, anti-noise for the noise source based on the received reference sensor signals;
transmit, by the one or more processors to one or more speakers to be broadcast from one or more speakers situated in relation to a quiet zone, the generated anti-noise;
receive, by the one or more processors, at least one error signal eₚ, related to residual noise, from each of one or more error microphone array unit situated in relation to the quiet zone, each error microphone array unit comprising a plurality of error microphones; and
adapt, by the one or more processors, the anti-noise based on the error signal to cancel noise from the noise source in the quiet zone.

20. A vehicle, comprising:
at least one reference sensor;
at least one speaker;
at least one error microphone array unit, each error microphone array unit comprising at least two error microphones;
a memory storing instructions therein; and
one or more processors:
communicatively coupled with i) the memory, ii) each reference sensor, iii) each speaker, and iv) each error microphone array unit; and
configured to execute the instructions to:
receive reference sensor signals related to a noise source from each reference sensor situated in relation to the noise source;
generate anti-noise for the noise source based on the received reference sensor signals;
transmit the generated anti-noise from the speaker situated in relation to a quiet zone;
receive at least one error signal eₚ, related to residual noise, from each error microphone array unit situated in relation to the quiet zone; and
adapt the anti-noise based on the error signal to cancel noise from the noise source in the quiet zone.
